(19) United States
(12) Patent Application Publication
(10) Pub. No.: US 2017/0082086 A1
(43) Pub. Date: Mar. 23, 2017

(54) APPARATUS FOR GENERATING ELECTRICITY FROM A TIDAL OR OCEAN CURRENT WATER FLOW

(71) Applicant: Ocean Current Energy LLC, London (GB)

(72) Inventor: Patrick James Mulvey, San Diego, CA (US)

(21) Appl. No.: 15/126,506

(22) PCT Filed: Mar. 12, 2015
(86) PCT No.: PCT/GB2015/000089

§ 371 Date: Sep. 15, 2016

(30) Foreign Application Priority Data
Mar. 18, 2014 (GB) 1404883.9

(51) Int. Cl. F03B 13/26; F03B 13/10; H02K 7/18; F03B 17/06

(52) U.S. Cl. CPC F03B 13/264; F03B 17/061; F03B 13/10; H02K 7/1823; F05B 2240/40; F05B 2240/917; F05B 2240/97; F05B 2250/132; F05B 2250/283; F05B 2270/18

(57) ABSTRACT

Apparatus (2) for generating electricity from a tidal water flow, which apparatus comprises: a plurality of electrical generators (4) for generating electricity; and connection means for electrically connecting the electrical generators (4) together; wherein each electrical generator (4) comprises a rotor (6), a stator (8), and a housing (10); the housing (10) is a multi-sided housing constructed such that the electrical generators (4) are stably connectable together; the housing (10) is open at both ends; the stator (8) is inside at least a part of the housing (10); the rotor (6) comprises a plurality of magnets (18) positioned around the periphery of the rotor (6); the magnets (18) are encased in a protective material (20) which protects the magnets (18) from the water; and the rotor (6) has vanes (22) which cause the rotor (6) to rotate within the stator (8) as the water flows through the housing (10).

This invention relates to apparatus for generating electricity and, more especially, this invention relates to apparatus for generating electricity from a tidal or ocean current water flow.

There are many different types of known apparatus for generating electricity from a tidal or ocean current water flow. The water may be sea water or river water. Tides or ocean currents cause the water to flow, and it is this flow which is used by the apparatus in order to generate the electricity. Often the known apparatus is difficult to manufacture, install, operate and repair.

It is an aim of the present invention to reduce the above mentioned problems.

Accordingly, in one non-limiting embodiment of the present invention there is provided apparatus for generating electricity from a tidal or ocean current, which apparatus comprises:
(i) a plurality of electrical generators for generating electricity; and
(ii) connection means for electrically connecting the electrical generators together such that the generated electricity is able to be directed to wherever desired;
   and the apparatus being characterised in that:
(iii) each electrical generator comprises a rotor, a stator, and a housing;
(iv) the housing is a multi-sided housing constructed such that the electrical generators are stably connectable together;
(v) the housing is open at both ends so that the water can flow in either direction through the housing;
(vi) the stator is inside at least a part of the housing;
(vii) the rotor comprises a plurality of magnets positioned around the periphery of the rotor;
(viii) the magnets are encased in a protective material which protects the magnets from the water; and
(ix) the rotor has vanes which cause the rotor to rotate within the stator as the water flows through the housing, and thereby to generate the electricity.

The apparatus of the present invention is advantageous in that the housings of the electrical generators are easily connectable together in a stable manner. Also, the housings enable the electrical generators to be easily separated such that replacement of a separate housing in the event of a malfunction is easily effected. The electrical generators are compact due to the fact that the rotor and the stator are inside the housing of each electrical generator. The positioning of the magnets around the rotor does not require complicated machinery. The stator may comprise a coil which is able to be located easily inside at least a part of the housing, i.e. completely within the housing or only within a part of the housing. The housing may be regarded as a caisson. The apparatus is able to operate with a flow of water in both directions through the housing.

The apparatus may be one in which the magnets are located in pockets. Preferably each magnet has its own pocket. However, two or more magnets may be located in a single pocket if desired.

The protective material may be sheet material. Other protective materials such for example as mastic material may be employed.

Where the protective material is a sheet material, then the sheet material is preferably a para-aramid synthetic fibre, for example Kevlar (Registered Trade Mark).

The apparatus may include positioning means for adjusting the height of the apparatus from the waterbed of the water in which the apparatus is positioned. The positioning means may comprise cables. The waterbed will be a seabed in the case of the apparatus being positioned in a sea, and the waterbed will be a riverbed in the case of the apparatus being positioned in a river or strait.

The apparatus may include height adjusting means.

The apparatus may be one in which the height adjusting means comprises a first cable which is vertically positioned and in which the positioning means comprises a plurality of second cables which extend at angles to the waterbed and which maintain the first cable vertically positioned. Thus the second cables prevent the force of the flowing water from causing the apparatus to move from its desired position.

Embodiments of the invention will now be described solely by way of example and with reference to the accompanying drawings in which:

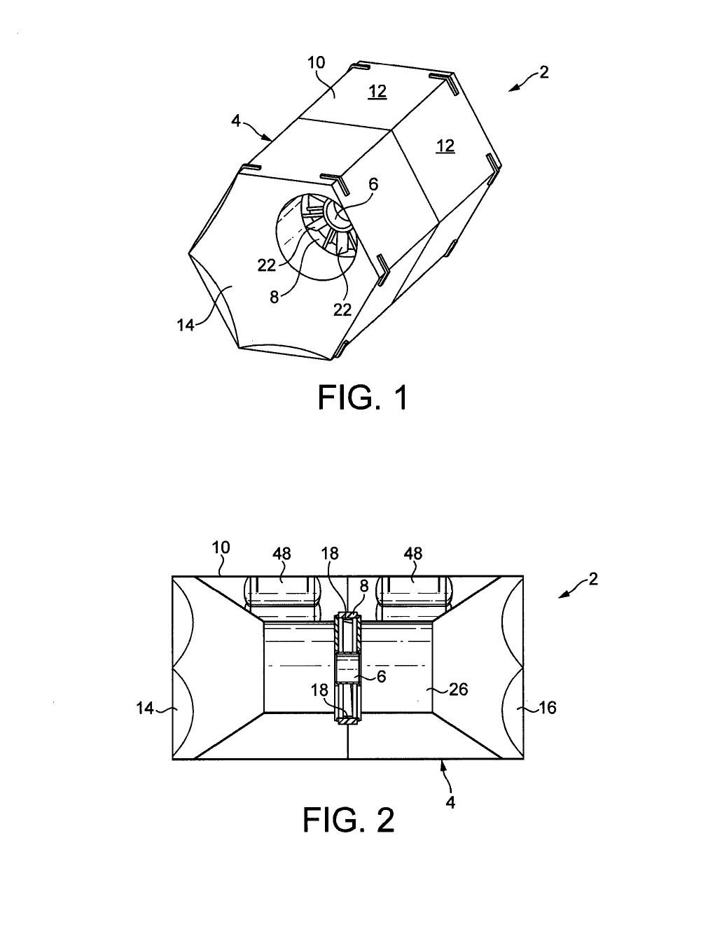

FIG. 1 is a perspective view of an electrical generator used in the apparatus of the present invention;

FIG. 2 is a longitudinal section through the electrical generator as shown in FIG. 1;

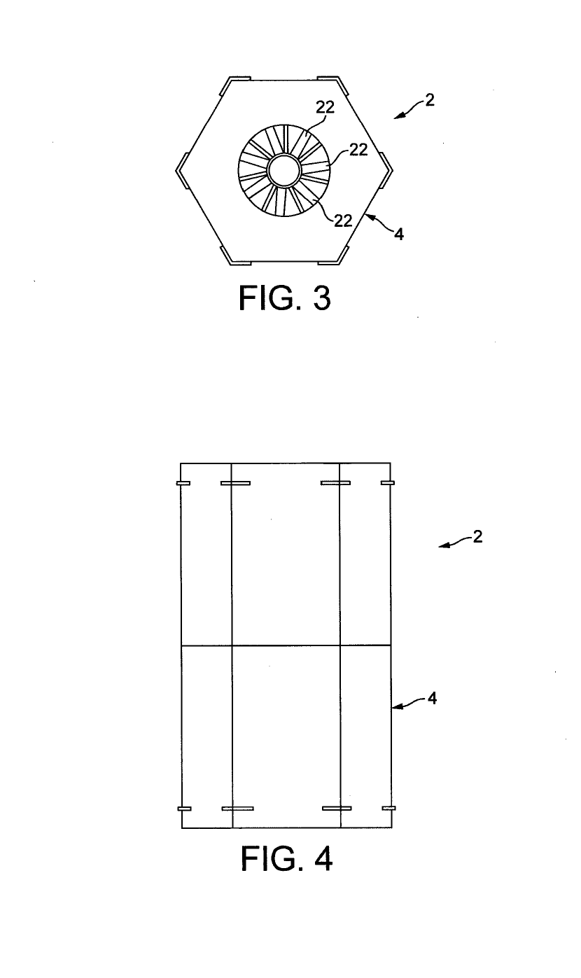

FIG. 3 is an end view of the electrical generator shown in FIG. 1;

FIG. 4 is a top view of the electrical generator shown in FIG. 1;

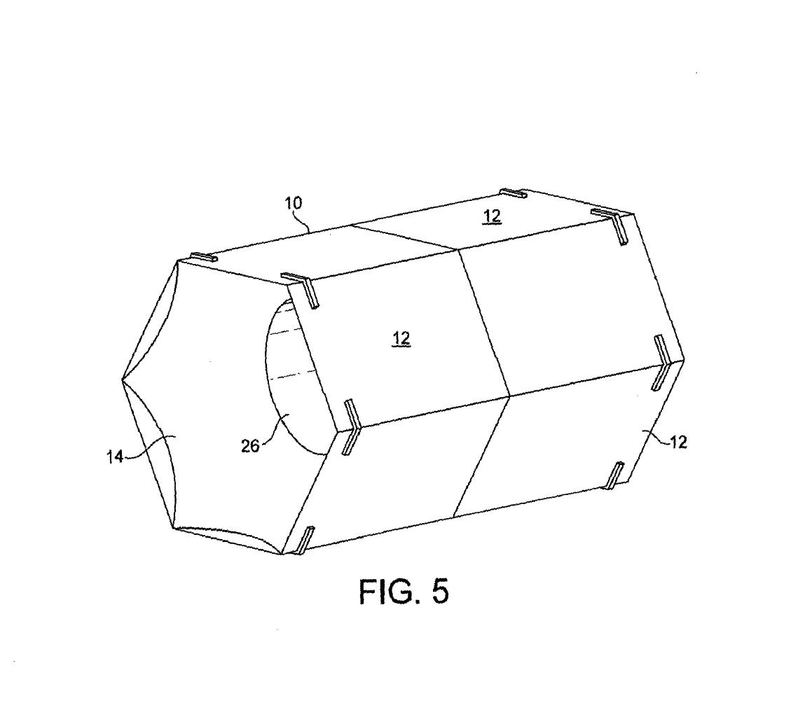

FIG. 5 is an enlarged view of a housing forming part of the electrical generator shown in FIG. 1;

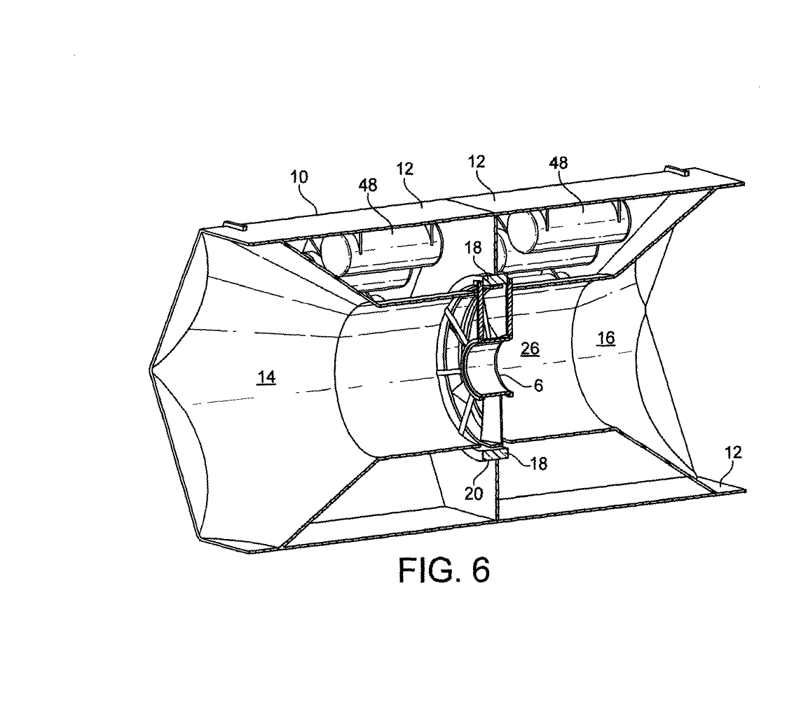

FIG. 6 is an enlarged perspective view of the apparatus as shown in FIG. 2;

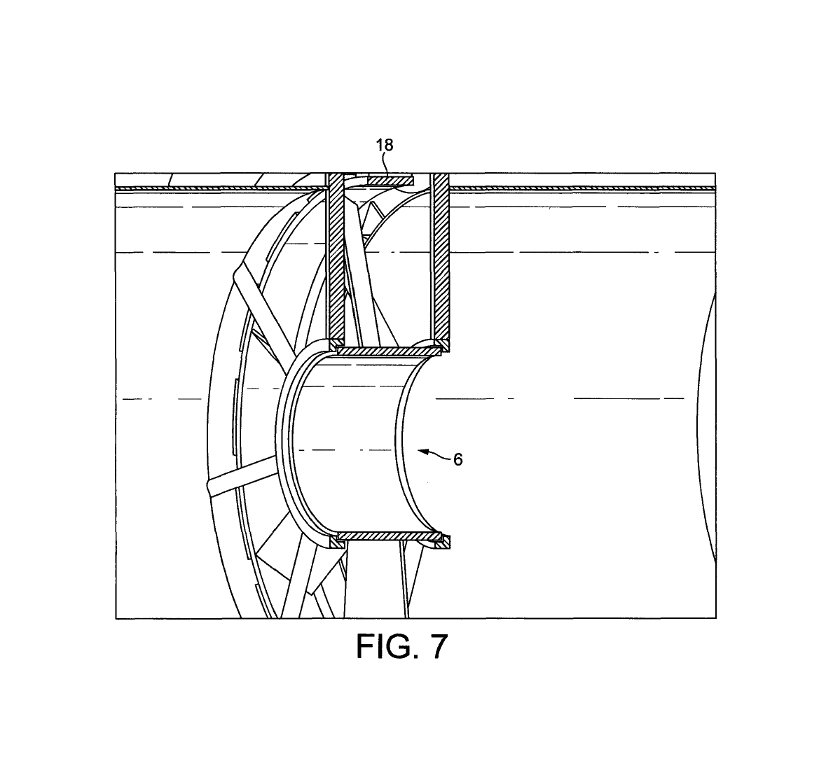

FIG. 7 is an enlarged view of a rotor and stator part of the electrical generator as shown in FIG. 6;

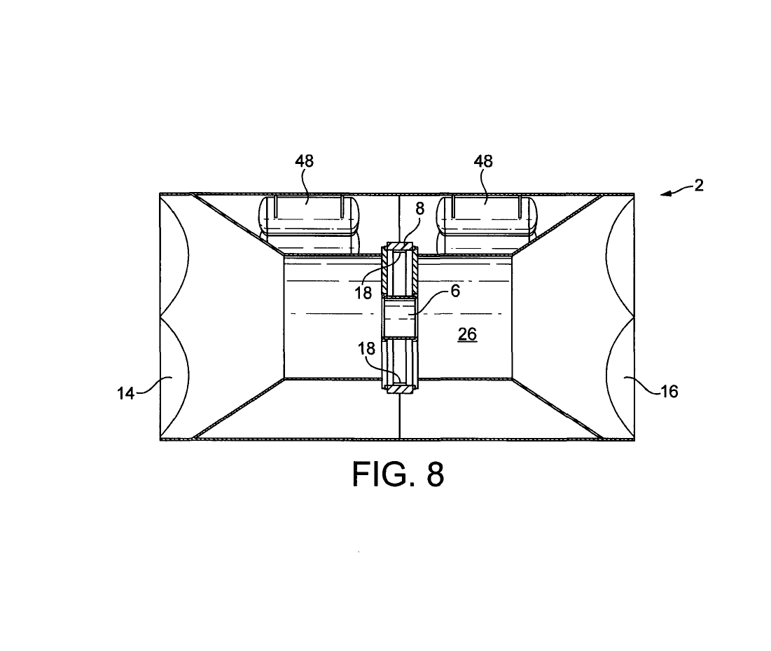

FIG. 8 is an enlarged view of the electrical generator as shown in FIG. 2;

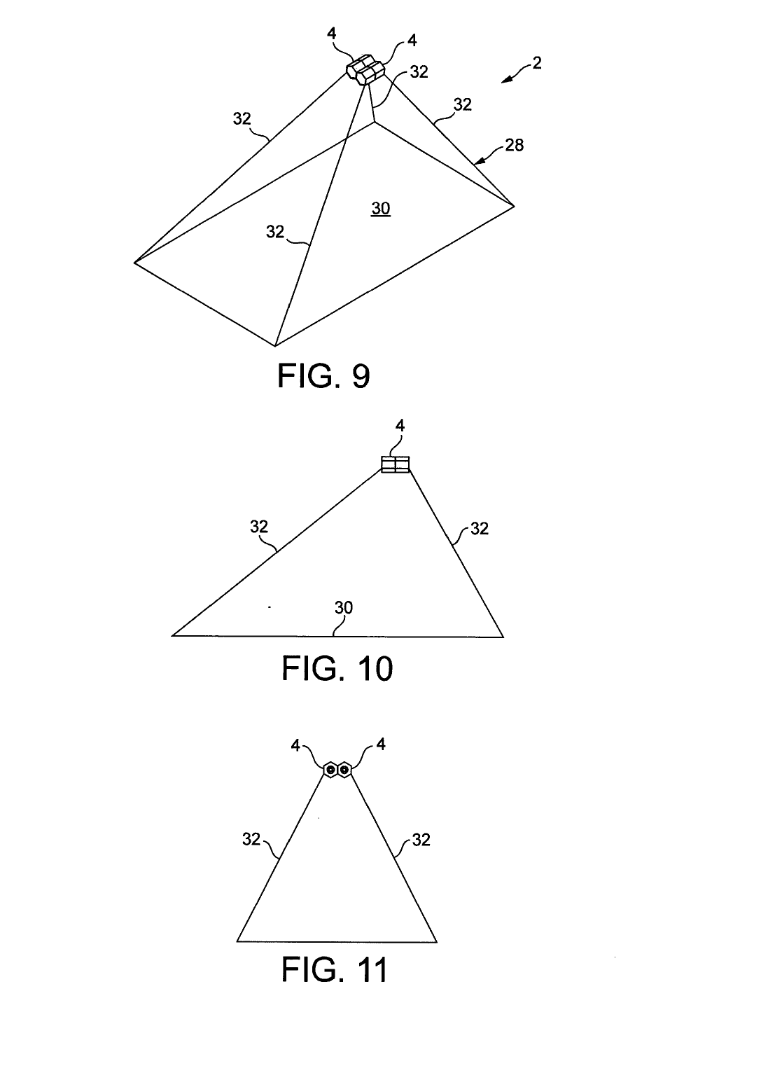

FIG. 9 shows part of first apparatus of the present invention in use, with apparatus including positioning means;

FIG. 10 is a side view of the apparatus as shown in FIG. 9;

FIG. 11 is an end view of the apparatus as shown in FIG. 9;

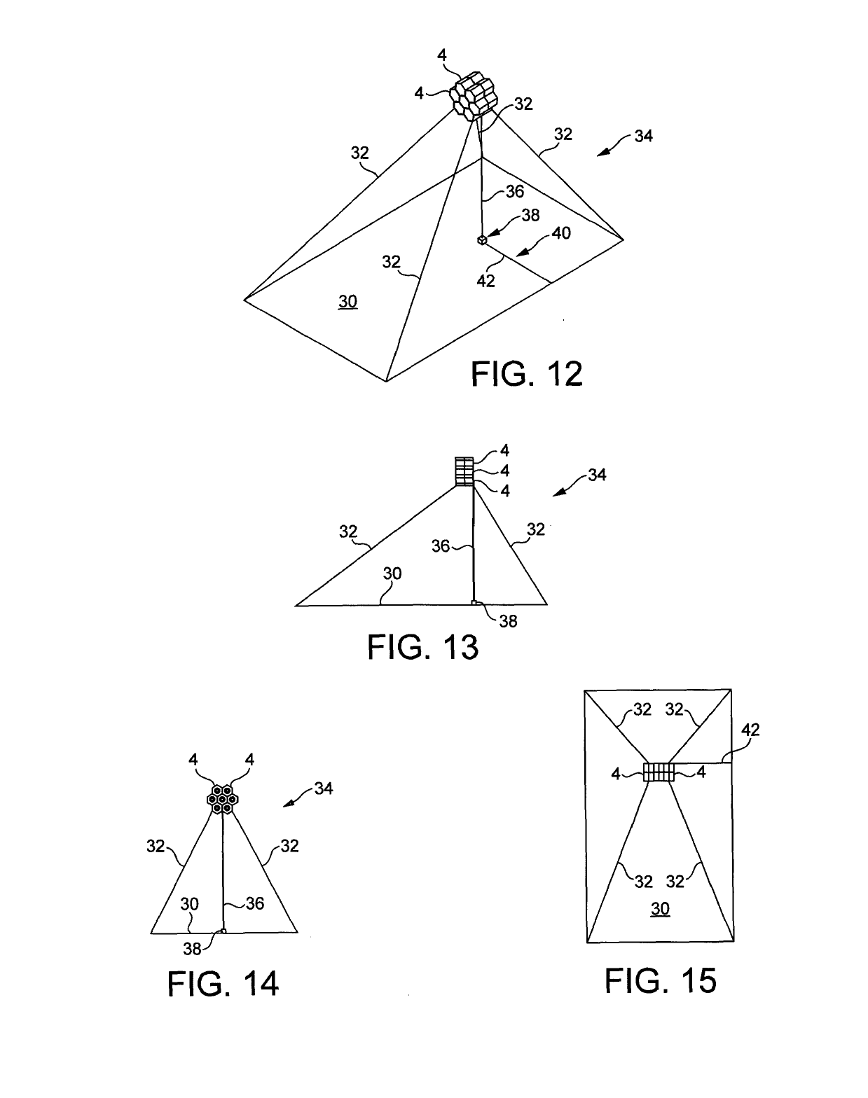

FIG. 12 is a perspective view of second apparatus of the present invention, with the apparatus including positioning means;

FIG. 13 is a side view of the apparatus as shown in FIG. 12;

FIG. 14 is an end view of the apparatus as shown in FIG. 12;

FIG. 15 is a top view of the apparatus as shown in FIG. 12;

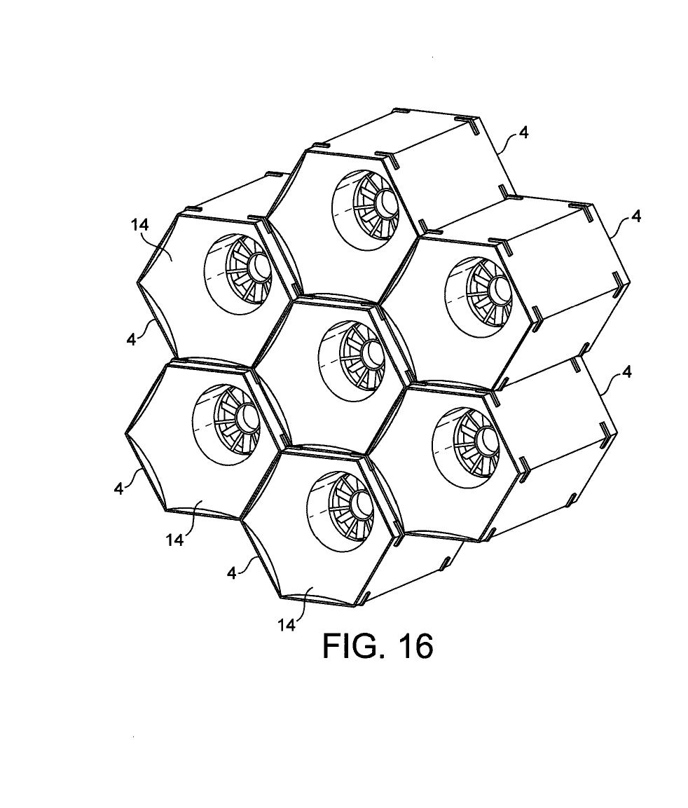

FIG. 16 is a perspective view of the connected electrical generators shown in the apparatus of FIG. 12;

FIG. 17 shows third apparatus of the present invention, with the apparatus including a plurality of electrical generators secured to a base;

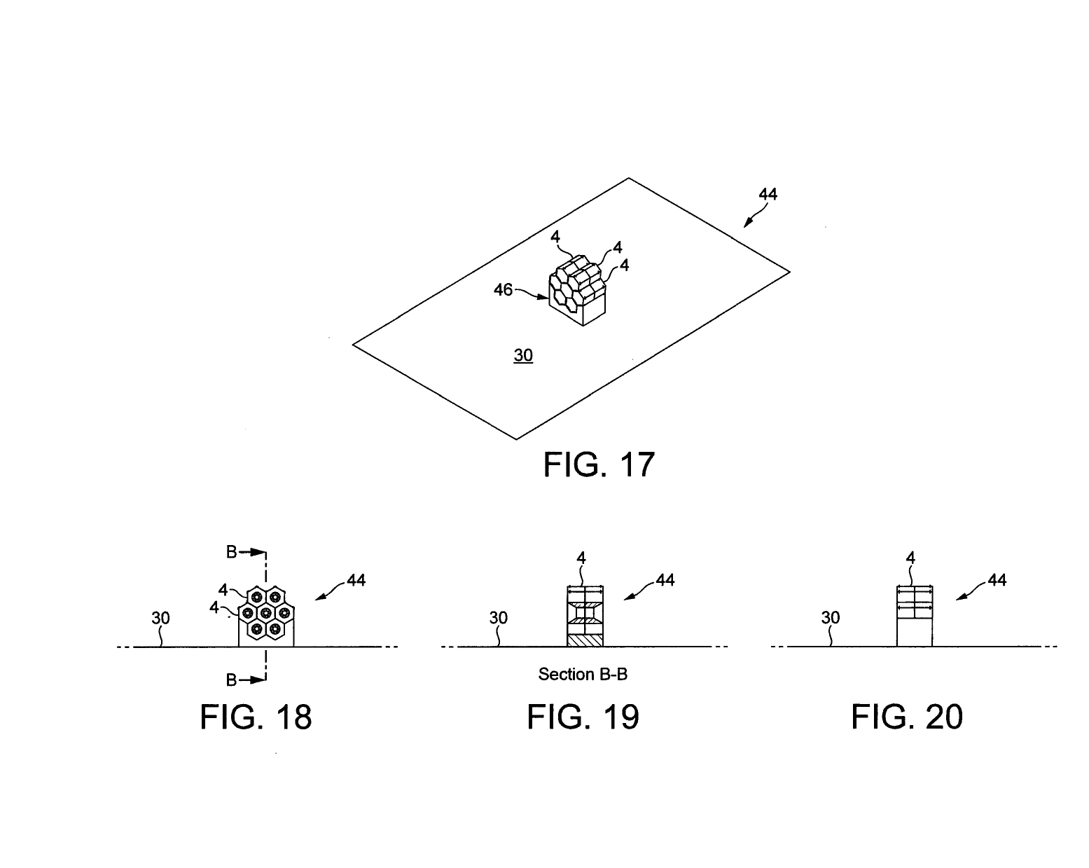

FIG. 18 is an end view of the apparatus as show in FIG. 17;

FIG. 19 is a section on line BB shown in FIG. 18;

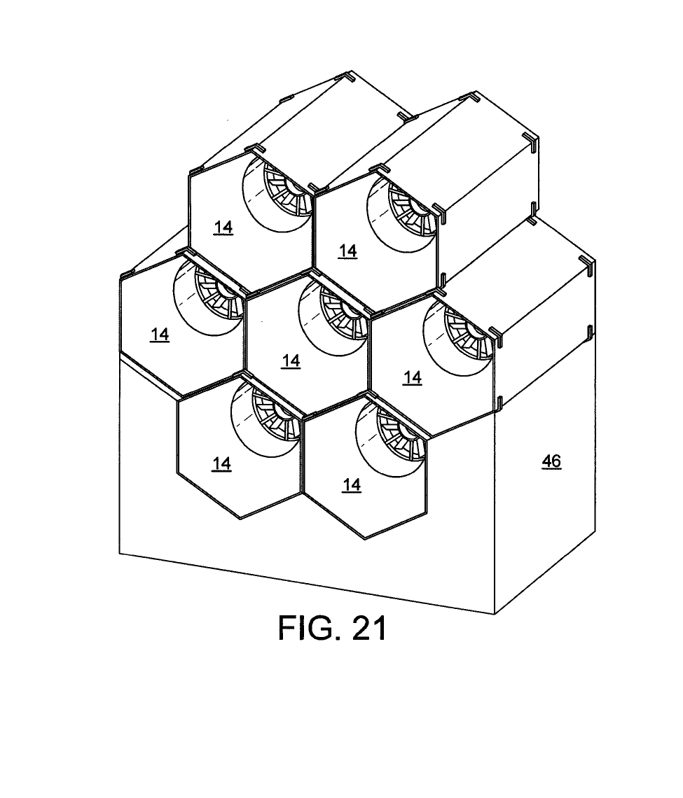

FIG. 20 is an end view of the apparatus shown in FIG. 17; and

FIG. 21 is an enlarged perspective view of the plurality of electrical generators and their base as shown in FIG. 17.

Referring to FIGS. 1-8, there is shown part of first apparatus 2 for generating electricity from a tidal or ocean current flow. More specifically, FIGS. 1-8 show an electrical generator 4 for generating electricity. The electrical generator 4 comprises a rotor 6, a stator 8, and a housing 10.

The housing 10 is a multi-sided housing 10 having six flat sides 12 as can best be appreciated from FIG. 1. The housing 10 is constructed such that it can be connected to other similar housings 10. Thus the electrical generators 4 are connectable together in an easy manner. Also, the connected electrical generators are able to be very stably connected together. This is advantageous in use where tidal or ocean current water flows may subject an assembly of the electrical generators to substantial forces. The housing 10 is open at both ends 14, 16 so that the water can flow in either direction through the housing 10.

The stator 8 is inside the housing 10.

The rotor 6 comprises a plurality of magnets 18 positioned around the periphery of the rotor 6. The magnets 18 are encased in a protective material 20 which protects the magnets from the water. The rotor 6 has vanes 22 which cause the rotor 6 to rotate within the stator 8 as the water flows through the housing 10. The rotation of the rotor 6 within the stator 8 generates the electricity. Each stator 8 may comprise a coil, for example a copper wire coil suitably protected against corrosion from the water.

The magnets 18 are located in pockets. Each magnet 18 may have its own pocket.

The protective material 20 is sheet material. The sheet material is made of Kevlar or a similar material.

As can best be seen from FIG. 2, the ends 14, 16 are frusto-conical in shape and they lead to a central parallel sided tubular portion 26 in which the rotor 6 is located. The tubular portion is narrower than the openings defined by the ends 14, 16. A Venturi effect is developed by the tapering of the inflow from either end 14, 16 to the narrower aperture at the rotor 6.

Referring now to FIGS. 9, 10 and 11, the apparatus 2 is shown such that two of the electrical generators 4 are connected together. The apparatus 2 includes positioning means 28 for positioning the apparatus 2 above a waterbed 30. The positioning means 28 comprises four cables 32.

Referring now to FIGS. 12-16, there is shown second apparatus 34 of the present invention. Similar parts as in the apparatus 2 as shown in FIGS. 9-11 have been given the same reference numerals for ease of comparison and understanding. In the apparatus 34, it will be seen that there are seven of the electrical generators 4 connected together. There is also provided a vertical cable 36. The vertical cable 36 acts as height adjusting means for adjusting the height of the electrical generators 4 above the waterbed. Also shown is a power transmission unit 38. The power transmission unit 38 forms part of connection means 40 for electrically connecting the electrical generators 4 together such that the generated electricity is able to be directed to wherever desired. The connection means 40 is shown with a power takeoff cable 42.

FIG. 16 is a perspective view of the seven connected electrical generators 4 shown in FIG. 12-15.

FIG. 17-21 show third apparatus 44 of the present invention. Similar parts as in previous Figures have been given the same reference numerals for ease of comparison and understanding. In FIGS. 17-20, it will be seen that the six connected electrical generators 4 are mounted to a base in the form of a concrete base 46. The base 46 is shown connected to the waterbed 30.

FIG. 21 is a perspective view of the seven connected electrical generators 4 mounted on the concrete base 46.

The apparatus 2, 34, 44 is easily manufactured, connected together, installed and repaired. If one of the electrical generators 4 should fail, it is relatively easy to remove that electrical generator 4 and replace it without having to raise all the connected electrical generators 4 to the water surface and to a repair vessel. The provision of the rotor 6 in the stator 8, and the magnets 18 around the periphery of the rotor 8, provides a construction which is both compact and robust.

As shown in FIGS. 2, 6 and 8, the electrical generators 4 are provided with buoyancy means in the form of air tanks 48. The air tanks 48 are advantageously used to give the apparatus of the present invention required buoyancy, for example when it is floating. The buoyancy may also be required even when the electrical generators 4 are connected to the base 46. For example, if an electrical generator 4 becomes defective and has to be repaired, then the use of the air tanks 48 may enable the electrical generator 4 to be floated to the surface for replacement or repair as appropriate.

It is to be appreciated that the embodiments of the invention described above with reference to the accompanying drawings have been given by way of example only and that modifications may be effected. The housing may have more or less than six flat sides. The apparatus may be positioned in seas, rivers, straits and estuaries. Individual components shown in the drawings are not limited to use in their drawings and they may be used in other drawings and in all aspects of the invention.

1. Apparatus for generating electricity from a tidal or ocean current water flow, which apparatus comprises:
(i) a plurality of electrical generators for generating electricity; and
(ii) connection means for electrically connecting the electrical generators together such that the generated electricity is able to be directed to wherever desired;
and the apparatus being characterised in that:
(iii) each electrical generator comprises a rotor, a stator, and a housing;
(iv) the housing is a multi-sided housing constructed such that the electrical generators are stably connectable together;
(v) the housing is open at both ends so that the water can flow in either direction through the housing;
(vi) the stator is inside at least a part of the housing;
(vii) the rotor comprises a plurality of magnets positioned around the periphery of the rotor;
(viii) the magnets are encased in a protective material which protects the magnets from the water; and
(ix) the rotor has vanes which cause the rotor to rotate within the stator as the water flows through the housing, and thereby to generate the electricity.

2. Apparatus according to claim 1 in which the magnets are located in pockets.

3. Apparatus according to claim 2 in which each magnet has its own pocket.

4. Apparatus according to claim 1 in which the protective material is sheet material.

5. Apparatus according to claim 4 in which the sheet material is a para-aramid synthetic fibre.

6. Apparatus according to claim 1 and including positioning means for positioning the apparatus above a waterbed.

7. Apparatus according to claim 6 in which the positioning means comprises cables.

8. Apparatus according claim 1 and including height adjusting means.

9. Apparatus according to claim 8 in which the height adjusting means comprises a first cable which is vertically positioned, and in which the positioning means comprises a plurality of second cables which extend at angles to the waterbed and which maintain the first cable vertically positioned.

10. Apparatus according claim 1 and including buoyancy means.

11. Apparatus according to claim 10 in which the buoyancy means comprises at least one air tank.
